(19) United States
(12) Patent Application Publication
(10) Pub. No.: US 2024/0423231 A1
(43) Pub. Date: Dec. 26, 2024

(54) food and drinks.

(71) Applicant: Menni Menashe Zinger, Ashkelon (IL)

(72) Inventor: Menni Menashe Zinger, Ashkelon (IL)

(73) Assignee: Menni Menashe Zinger, Ashkelon (IL)

(21) Appl. No.: 18/213,247

(22) Filed: Jun. 22, 2023

(51) Int. Cl. A23F 3/14; A23F 3/40

(52) U.S. Cl. CPC A23F 3/14; A23F 3/405

(57) ABSTRACT

At this invention I present new soft drinks with great taste.

At claim 1: I discovered that tea/tea leaves can create good taste for soft drinks and also quacker by basing on my other invention and understanding that there is connection between tea and quacker at their caricature and their boat work the same as the medication risperidone

At claim 2 and 1: I based on that that it is forbidden to drink tea together with risperidone and understand that anti depressant medications and risperidone and other similar medications can be used at right doses in order to produce soft drinks, with gas or without and tea like drink too.

At claim 3: I assume and discover that barley gens can be used in order to improve wheat ability to survive at difficult weather and difficult conditions of cold, heat and moister also using other grain/cereal plants gens in order to strengthen the abilities of wheat and corn also. Also using sabra, tsabar gens in order to improve the abilities of wheat and corn that based on the logic that those added gens will strengthen the plant and make them better survivors.

1. Using tea and or tea leaves and/or quaker in order to produce soft drink with or without gas .also with combination of lemon taste. also adding zinc in order to improve taste and manhood.

2. Using anti depressant medication and perphenazine or risperidone ingredients in order to create new taste for soft drinks.

3. Using barley gens in order to improve wheat ability to survive at difficult weather and difficult conditions of cold, heat and moister also using other grain, cereal plants gens in order to strengthen the abilities of wheat and corn also. Also using sabra, tsabar gens in order to improve the abilities of wheat and corn.
